(19) United States
(12) Patent Application Publication
(10) Pub. No.: US 2019/0271766 A1
(43) Pub. Date: Sep. 5, 2019

(54) FIBER SCANNER HAVING AT LEAST TWO FIBERS

(71) Applicant: Blickfeld GmbH, Muenchen (DE)

(72) Inventor: Florian Petit, Muenchen (DE)

(21) Appl. No.: 16/347,889

(22) PCT Filed: Nov. 7, 2017
(86) PCT No.: PCT/DE2017/100940

§ 371 Date: May 7, 2019

(30) Foreign Application Priority Data
Nov. 7, 2016 (DE) 10 2016 013 227.2

(51) Int. Cl. G01S 7/481; G02B 26/10

(52) U.S. Cl. CPC G01S 7/4817; G02B 26/103; G01S 7/4818

(57) ABSTRACT

A device (100) comprises at least two fiber-shaped elements (101-103) which are arranged between a fastening means (141) and a deflecting unit (142). The deflecting unit (142) is configured to deflect light (146). The device (100) also comprises an actuator which is configured to induce at least one degree of freedom of motion of the at least two fiber-shaped elements (101-103).

### TECHNICAL FIELD

Various examples of the invention relate in general to a fiber scanner which is configured to deflect light. Various examples of the invention relate in particular to a device having at least two fiber-shaped elements which are arranged between a fastening means and a deflecting unit.

### BACKGROUND

The distance measurement of objects is desirable in various technology fields. For example, in the context of autonomous driving applications, it can be desirable to detect objects in the surroundings of vehicles and, in particular, to determine a distance to the objects.

One technique for distance measurement of objects is the so-called LIDAR technology (Light detection and ranging; sometimes also LADAR). Here, pulsed laser light is emitted by an emitter. The objects in the surroundings reflect the laser light. These reflections can subsequently be measured. By determining the propagation time of the laser light, a distance to the objects can be determined.

For the spatially resolved detection of the objects in the surroundings, it is possible to scan the laser light. Depending on the radiation angle of the laser light, different objects in the surroundings can thereby be detected.

However, conventional spatially resolved LIDAR systems present the disadvantage that they can be relatively expensive, heavy, maintenance-intensive and/or large. Typically, in LIDAR systems, a scanning mirror which can be moved into different positions is used. Often, the scanning mirror is large, and the adjustment mechanism can be maintenance-intensive and/or expensive.

From Leach, Jeffrey H., Stephen R. Chinn, and Lew Goldberg. “Monostatic all-fiber scanning LADAR system,” Applied optics 54.33 (2015): 9752-9757, techniques are known for carrying out a scanned LIDAR measurement by means of an adjustable curvature of an optical fiber. A fiber scanner is described. Corresponding techniques are also known from Mokhtar, M. H. H., and R. R. A. Syms. “Tailored fibre waveguides for precise two-axis Lissajous scanning ” Optics express 23.16 (2015): 20804-20811.

Such techniques have the disadvantage that the curvature of the optical fiber is relatively limited. In addition, it can be difficult to implement an optics system in such a manner as to avoid a beam divergence of laser light exiting from the end of the optical fiber.

### BRIEF DESCRIPTION OF THE INVENTION

Therefore, there is a need for improved techniques for measuring distances of objects in the surroundings of a device. In particular, there is a need for such techniques which remedy at least some of the above-mentioned limitations and disadvantages.

In an example, a device comprises at least two fiber-shaped elements. The at least two fiber-shaped elements are arranged between a fastening means and a deflecting unit. The device also comprises the deflecting unit. The deflecting unit is configured to deflect light. The device also comprises an actuator configured to induce at least one degree of freedom of motion of the at least two fiber-shaped elements.

For example, the actuator can he configured to induce the at least one degree of freedom of motion of the at least two fiber-shaped elements in a coupled manner The at least one degree of freedom of motion can comprise a torsion mode of the at least two fiber-shaped elements.

For example, the device could comprise a laser light source which is configured to emit the laser light. For example, the device could comprise a detector which is configured to detect reflected laser light. For example, a single photon avalanche detector (SPAD) array could be used. For example, the device could comprise a LIDAR control unit which is configured to control the laser light source and the detector and to determine a distance of objects in the surroundings based on a propagation time of the laser light between laser light source and detector.

A method comprises, by means of an actuator: inducing a torsion mode of at least two fiber-shaped elements which are arranged between a fastening means and a deflecting unit. Here, the deflecting unit is configured to deflect light. By inducing the torsion mode, a twisting of the at least two fiber-shaped elements into one another about a central axis of the at least two fiber-shaped elements occurs. In addition, due to the inducing of the torsion mode, a twisting of each fiber-shaped element of the at least two fiber-shaped elements about the corresponding longitudinal axis also occurs. The inducing of the torsion mode can occur in a coupled manner.

The above-presented features and features described below can be used not only in the corresponding explicitly described combinations but also in other combinations or individually, without leaving the scope of protection of the present invention.

### BRIEF DESCRIPTION OF THE FIGURES

FIG. 1 diagrammatically illustrates a fiber scanner according to various examples, wherein the fiber scanner comprises three fibers arranged rotationally symmetrically with respect to a central axis.

FIG. 2 diagrammatically illustrates the fiber scanner according to the example of FIG. 1 in enlarged detail, wherein FIG. 2 illustrates in particular the deflecting unit having a mirror.

FIG. 3 is a cross-sectional view of the fiber scanner according to the example of FIG. 1 in a resting state.

FIG. 4 is a cross-sectional view of the fiber scanner according to the example of FIG. 1 in an excited state, wherein a torsion mode is represented in FIG. 4.

FIG. 5 is a cross-sectional view of the fiber scanner according to the example of FIG. 1 in an excited state, wherein a transverse mode is represented in FIG. 5.

FIGS. 6 and 7 diagrammatically illustrate the transverse mode according to various examples.

FIG. 8 diagrammatically illustrates a spectrum of the degrees of freedom of motion of the fibers of the fiber scanner according to various examples.

FIG. 9 diagrammatically illustrates a spectrum of the degrees of freedom of motion of the fibers of the fiber scanner according to various examples.

FIG. 10 diagrammatically illustrates a fiber scanner according to various examples, wherein the fiber scanner comprises four fibers arranged rotationally symmetrically with respect to a central axis.

### DETAILED DESCRIPTION OF EMBODIMENTS

The above-described characteristics, features and advantages of this invention and the manner in which they are achieved are clarified and can be better understood based on the following description of the embodiment examples which are explained in further detail in reference to the drawings.

Below, the present invention is explained in further detail based on preferred embodiments in reference to the drawings. In the figures, identical reference numerals denote identical or similar elements. The figures are diagrammatic representations of different embodiments of the invention. Elements represented in the figures are not necessarily represented true to scale. Instead, the different elements represented in the figures are reproduced in such a manner that their function and general purpose are understandable to the person skilled in the art. Connections and couplings between functional units and elements represented in the figures can also be implemented as direct connection or coupling. Functional units can be implemented as hardware, software or as a combination of hardware and software.

Below, various techniques for scanning light are described. The techniques described below can enable, for example, the two-dimensional scanning of light. The scanning can denote repeated emission of the light at different radiation angles. For this purpose, the light can be deflected by a deflecting unit. The scanning can refer to the repeated scanning of different points in the surroundings by means of the light. For example, the number of different points in the surroundings and/or the number of different radiation angles can establish an image region.

In various examples, the scanning of light can occur by the temporal superposition and optionally by a spatial superposition of two motions in accordance with different degrees of freedom of at least one mobile element. Thereby, in various examples, a superposition figure can be traced. Sometimes, the superposition figure is also referred to as a Lissajous figure. The superposition figure can describe a sequence with which different radiation angles are implemented.

In various examples, it is possible to scan laser light. Here, for example, coherent or incoherent laser light can be used. It would be possible to use polarized or unpolarized laser light. For example, it would be possible to use the laser light in a pulsed manner. For example, short laser pulses having pulse widths in the range of femtoseconds or picoseconds or nanoseconds can be used. For example, a pulse duration can be in the range of 0.5-3 nanoseconds. The laser light can have a wavelength in the range of 700-1800 nm. For the sake of simplicity, reference is made below primarily to laser light; however, the various examples described herein can also be used for the scanning of light from other light sources, for example, broad-band light sources or RGB light sources. RGB light sources here denote in general light sources in the visible spectrum, wherein the color space is covered by superposition of several different colors for example, red, green, blue or cyan, magenta, yellow, black.

In various examples, a mobile end of a fiber-shaped element or of multiple fiber-shaped elements, hereafter referred to simply as fibers, is used for the scanning of the laser light.

Different types of fibers can be used. For example, optical fibers can be used, which are also referred to as glass fibers. However, this is not necessary. In fact, here the fibers do not have to be produced from glass. The fibers can be produced, for example, from plastic, glass, silicon or another material. For example, the fibers can be produced from quartz glass. For example, the fibers can have a modulus of elasticity of 70 GPa or a modulus of elasticity in the range of 40 GPa-80 GPa, preferably in the range 60-75 GPa. For example, the fibers can have a modulus of elasticity in the range of 140 GPa-200 GPa. For example, the fibers can enable up to 4% material elongation. In some examples, the fibers have a core in which the fed-in laser light propagates and is enclosed by total reflection at the margins (optical waveguide). However, the fiber does not have to have a core. In various examples, so-called single mode optical fibers (single mode fibers) or multimode optical fibers (multimode fibers) are used. The different fibers described herein can have a circular cross section, for example. For example, it would he possible for the different fibers described herein to have a diameter which is not less than 50 μm, optionally not <150 μm, moreover optionally not <500 μm, moreover optionally not <1 mm. However, the diameter can also be <1 mm, optionally <500 μm, moreover optionally less than 150 μm. For example, the different fibers described herein can be designed so that they can be bent or curved, i.e., so as to be flexible. For this purpose, the material of the fibers described herein can have a certain elasticity. Therefore, the fibers can also be referred to as spring elements. The fibers can have, for example, a length in the range of 3 mm to 12 mm, optionally in the range of 4 mm to 8 mm.

For example, the mobile end of the fibers can be moved in one or two dimensions. For this purpose, one or more actuators can be used. For example, it would be possible for the mobile end of the fibers to be tilted with respect to a fastening means of the fibers; this results in a curvature of the fibers. This can correspond to a first degree of freedom of motion; said degree of freedom can he referred to as transverse mode (or also sometimes as wiggle mode). Alternatively or additionally, it would be possible to twist the mobile end of the fibers along the fiber axis (torsion mode). This can correspond to a second degree of freedom of motion. By the motion of the mobile end of the fibers, it is possible to achieve that laser light is emitted at different angles. For this purpose a deflecting unit can be provided. Thereby, surroundings can be scanned with the laser light. Depending on the extent of the motion of the mobile end, image regions of different size can be implemented.

In the various examples described herein, itis possible in each case to induce the torsion mode alternatively or additionally to the transverse mode, i.e., a temporal or spatial superposition of the torsion mode and the transverse mode would be possible. However, this temporal and spatial superposition can also be eliminated. In other examples, other degrees of freedom of motion could be implemented.

In various examples described herein, the fibers are used as holder for a deflecting unit. The deflecting unit can here be attached to the mobile ends of the fibers rigidly or stationarily, for example, by an adhesive. However, in the process, the laser light can reach the deflecting unit using an optical path other than through one or more of the fibers. In other words, the fibers are not necessarily used as optical waveguides for the laser light on the way to the deflecting unit. If the laser light does not reach the deflecting unit through the fibers, a complicated and elaborate coupling of the laser light into at least one of the fibers can be prevented. In addition, it is possible to use laser light, which, for example, comprises not only the local TEM00 mode, but alternatively or additionally other modes. This can enable the use of a particularly small laser, for example, a laser diode.

For example, the deflecting unit can be implemented as a prism or mirror. For example, the mirror could be implemented by a wafer, for example, a silicon wafer, or a glass substrate. For example, the mirror could have a thickness in the range of 0.05 μm-0.1 mm. For example, the mirror could have a thickness of 25 μm or 50 μm. For example, the mirror could have a thickness in the range of 25 μm to 75 μm. For example, the mirror could be designed to be square, rectangular or circular. For example, the mirror could have a diameter of 3 mm to 12 mm or of 8 mm in particular.

In general, such techniques for scanning light can be used in a wide variety of application fields. Examples include endoscopes, and RGB projectors, and printers. In various examples, LIDAR techniques can be used. The LIDAR techniques can be used to carry out a spatially resolved distance measurement of objects in the surroundings. For example, the LIDAR technique can include measurements of the propagation time of the laser light between the mobile end of the fibers, the object and a detector.

Although various examples with regard to LIDAR techniques have been described, the present application is not limited to LIDAR techniques. For example, the aspects described herein can be applied to the scanning of laser light by means of the mobile end of the fiber as well as for other applications. Examples include, for example, projecting image data on a projector here an RGB light source could be used, for example.

Various examples are based on the finding that it can be desirable to carry out the scanning of the laser light with high accuracy with regard to the radiation angle. For example, in connection with LIDAR techniques, a spatial resolution of the distance measurement can be limited by inaccuracy of the radiation angle. Typically, a higher (lower) spatial resolution is achieved, the more (less) accurately the radiation angle of the laser light can be determined.

Below, techniques are described for providing a particularly robust fiber scanner. In various examples, a fiber scanner comprises at least two fibers which are arranged between a fastening means and a deflecting unit. By using more than one fiber, it can be achieved that the load for example, material stresses which otherwise occurs in the individual fibers is distributed over more than one fiber. Thereby, particularly a long-lived fiber scanner can be provided. In addition, it can be achieved that outside interfering influences can be absorbed particularly well by the fiber scanner; for example, accelerations can have only a relatively small influence on the scanning of the laser light.

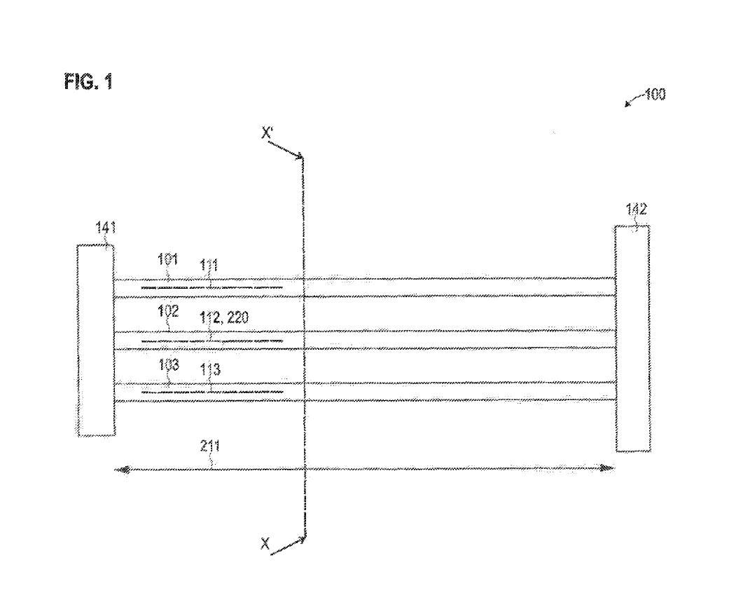

FIG. I illustrates aspects with regard to a fiber scanner 100 according to various examples. FIG. 1 shows a non-induced resting state of the fiber scanner 100. The fiber scanner 100 comprises a number of three fibers 101-103. Each of the fibers 101-103 is arranged between a fastening means 141 and a deflecting unit 142. The fibers 101-103 are straight, i.e., in the resting state they have no curvature or bends.

For example, the fastening means 141 can be implemented by a ferrule. It would be possible to use a single ferrule having several bores in which the different fibers 101-103 are inserted. However, in other examples it would also he possible for the fastening means 141 to he implemented by multiple ferrules, for example, one ferrule per fiber 101-103. Then, it would be possible for the different ferrules to be connected to one another, for example, to be glued to one another.

For example, it would be possible for the fiber scanner 100 to comprise an actuator (not represented in FIG. 1). For example, the actuator could be arranged adjacently to the fastening means 141. For example, the actuator could be implemented as piezo actuator, for example, as a piezo bending actuator. However, it would also be possible to use other actuators, for example, magnetic field coils. In principle, it is possible here that the actuator is configured to induce the different fibers 101-103 in a coupled manner. For example, for this purpose, a suitable inducing technique could be provided, which transfers motion to all the fibers 101-103. This means that a separate inducing of individual fibers 101-104 may not be possible or may be possible only to a limited extent. This can be achieved, for example, in that a piezo bending actuator induces all the fibers 101-104 together via a flux of force led through the fastening means 141. Correspondingly, this could be achieved in that the flux of force is applied to a magnetic material connected to all the fibers 101-104 by a common magnetic field of a magnetic field coil. Such techniques have the advantage that an energy-efficient and space-saving inducing is possible. In addition, due to the coupling, it is possible to prevent different actuators from having to be operated in a phase-coherent manner, which simplifies the implementation. By means of the coupled inducing, in particular a coupled torsion mode and/or a coupled transverse mode can be induced.

The actuator can be configured for the direct force action for inducing the degree of freedom of motion, i.e., the use of a parametric inducing as is the case, for example, in reference implementations with electrostatic interdigital finger structures, can be avoided.

For example, the fastening means 141 could be attached rigidly to a base plate or to a frame. In such an example, the ends of the fibers 101-103 arranged adjacently to the deflecting unit 142 can implement mobile ends. This means that the actuator can be configured to induce one or more degrees of freedom of motion of the fibers 101-103. For example, the actuator could be configured to induce a torsion mode of the fibers 101-103. Alternatively or additionally, the actuator could be configured to induce a transverse mode of the fibers 101-103. By the motion of the mobile end of the fibers 101-103, it can be achieved that the deflecting unit 142 is moved. For example, the deflecting unit 142 could be shifted and/or tilted. Thereby, light can be scanned.

In a simple example, the three longitudinal axes 101-103 of the fibers 101-103 could be arranged in one plane. However, in the example of FIG. 1 the three fibers 101-103 are not arranged in one plane, as will be explained in greater detail below.

In FIG. 1, a number of three fibers 101-103 is represented. However, in general it would also be possible for the fiber scanner 100 to have a smaller number or a higher number of fibers, for example, four or more fibers.

By the use of multiple fibers 101-103, it can be achieved that the stresses due to the motion of the fibers 101-103 are distributed over the different fibers 101-103. Thereby, it can be achieved that the material of the individual fibers 101-103 have to absorb relatively small stresses. In addition, it can he achieved that the connection points between the fastening means 141 and each of the fibers 101-103 have to transmit relatively small stresses. In such a manner, a useful life of the fiber scanner 100 can be increased.

In the example of FIG. 1, the fibers 101-103 are arranged parallel to one another. This means that the longitudinal axes 111-113 of the fibers pairwise in each case enclose angles with one another of approximately 0°. In general, it would be possible that the longitudinal axis 111-113 of the fibers 101-103 pairwise in each case enclose angles with one another which are not greater than 45°, optionally not greater than 10°, moreover optionally not greater than 1°.

In this manner, it is possible to achieve, inter alia, that the fiber scanner 100 has a relatively small extent perpendicular to the longitudinal axis 111-113 of the fibers 101-103. In addition, a particularly symmetric inducing of the motion of the fibers 101-103 in the different spatial directions can be achieved.

By arranging the fibers 101-103 substantially parallel to one another, it is possible to achieve that the fibers 111-113 have substantially the same length 211. For example, in FIG. 1, an implementation is represented in which the fibers 101-103 all have the same length 211. For example, the length 211 could be in the range of 2 mm to 20 mm, optionally in the range of 3 mm to 10 mm, moreover optionally in the range of 4 mm to 7 mm. In general, it would be possible for the fibers 101-103 to have lengths 211 which differ from one another by not more than 10%, optionally not more than 2%, moreover optionally not more than 0.1%.

Since the fibers 101-103 have substantially the same length 211, the following effect can be achieved: when the transverse mode of the fibers 101-103 is induced, no or no significant tilting of the deflecting unit 142 occurs; instead, a shifting of the deflecting unit 142 perpendicularly to the longitudinal axis 111-113 occurs. This means that undesired inducing of the transverse mode, for example, due to outside influences, does not bring about any significant change in the radiation angle of light deflected by the deflecting unit 142 (not represented in FIG. 1). Thereby, the fiber scanner 100 can be particularly robust with regard to outside influences.

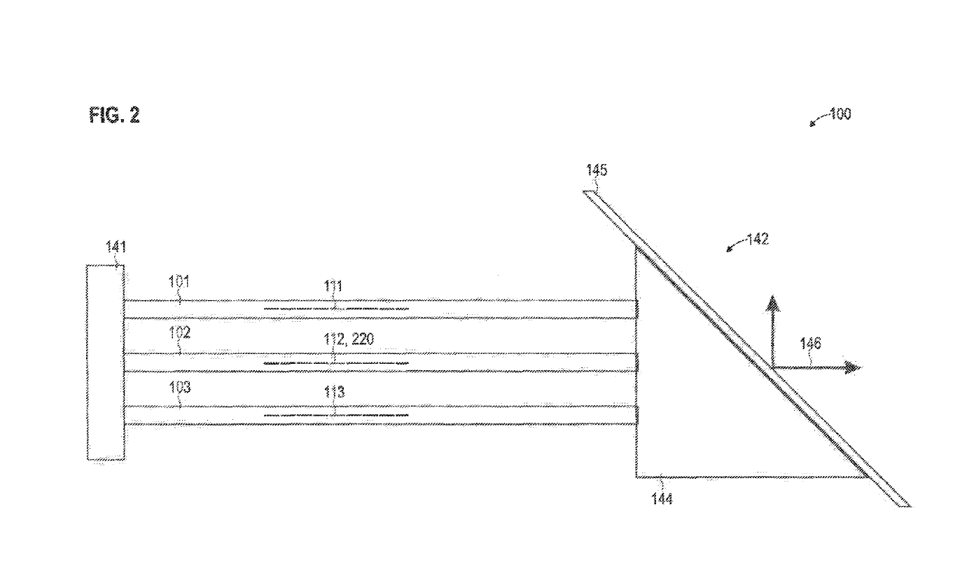

FIG. 2 illustrates aspects with regard to a fiber scanner 100 according to various examples. The fiber scanner 100 according to the example of FIG. 2 corresponds in principle to the fiber scanner 100 according to the example of FIG. 1. In FIG. 2 the deflecting unit 142 is moreover represented in greater detail. FIG. 2 also shows the resting state of the fiber scanner 100.

The deflecting unit 142 comprises an end piece 144 which, for example, could be implemented correspondingly to the fastening means 141 as a ferrule, etc. On the end piece 144, a mirror 145 is attached. This means that the end piece 144 is arranged on the back side of the mirror 145. It is apparent from FIG. 2 that the fibers 101-103 extend between the fastening means 141 and the end piece 144. The end piece 144 is attached between the mirror 145 and the fibers 101-103. From FIG. 2 it is also apparent that the fibers 101-103 extend away from a back side of the mirror 145, namely toward the fastening means 141. Thereby, frame-like structures requiring considerable space, as in conventional MEMS attachments, can be avoided. The deflecting unit 142 can be connected to the fibers 101-103 by the end piece 144. Thereby, a two- piece production is possible, so that no complicated integrated back side structuring as in conventional MEMS attachments has to occur.

In particular, the mirror 145 has a tilt with respect to the longitudinal axes 111-113 or in general with respect to the central axis 220 of approximately 45° in the case of FIG. 2. In general, the tilt with respect to the central axis 220 or in particular with respect to the longitudinal axes 111-113 can be in the range of 30°-50°. Thereby, it is possible to achieve that light 146 is deflected by the mirror 145, as in the example of FIG. 2. By inducing the torsion mode of the fibers 101-103, it is possible to achieve that the light 146 is deflected at different angles corresponding to the torsion angle. This corresponds approximately to the functioning of a periscope. The radiation angle of the light 146 is set by the rotation and the tilting of the mirror 145. if the torsion mode is used, only a rotation is present.

The periscope-like scanning by means of the torsion mode has the advantage that if the mirror 145 is also used as detector aperture the size of the detector aperture is not dependent on the scanning angle; the angle between incident light and mirror 145 is in fact not dependent on the scanning angle. This is different from reference implementations in which, by tilting the mirror, the size of the detector aperture and thus the sensitivity of the measurement varies as a function of the scanning angle.

In the example of FIG. 2, a scenario is represented in which the light 146 is not led through the fibers 101-103 toward the deflecting unit 142. In particular, in FIG. 2, a scenario is represented in which a beam path of the light 146 extends parallel to the longitudinal axes 111-113 of the fibers 101-103 and an additional beam path of the light 146 after or before deflection by the mirror extends perpendicularly to the longitudinal axes 111-113 of the fibers 101-103. In general, the beam path of the light 146 can extend parallel to the central axis 220. However, other implementations would. also be conceivable, in which the light 146 is led at least through at least one of the fibers 101-103 toward the deflecting unit 142. For this purpose, it would be possible, for example, for the light to be coupled into one or more of the fibers 101-103 at an end spaced away from the deflecting unit 142. In such a scenario, the deflecting unit 142 could be implemented, for example, as a lens and/or prism. For example, a gradient index (GRIN) lens could be used.

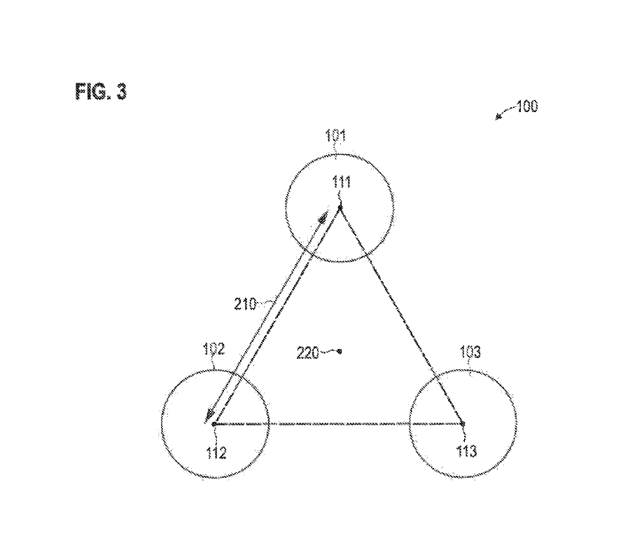

FIG. 3 illustrates aspects with regard to a fiber scanner 100 according to various examples. FIG. 3 here is a cross-sectional view along the section line X-X′ from FIG. 1. FIG. 3 also shows the resting state of the fiber scanner 100.

In the example of FIG. 3, the fibers 101-103 are arranged rotationally symmetrically with respect to a central axis 220 (the rotational symmetry is illustrated in the example of FIG. 3 by the dotted lines). In particular, a three-fold rotational symmetry is present. The presence of a rotational symmetry means, for example, that the system of the fibers 101-103 can be brought into superposition with itself by rotation. The order of the rotational symmetry denotes how often per 360° rotation angle the system of the fibers 101-103 can be brought into superposition with itself. In general, the rotational symmetry can be n-fold, wherein n denotes the number of the fibers used in the fiber scanner.

By the rotationally symmetrical arrangement, of high order, the following effect can be achieved: Nonlinearities when inducing the torsion mode of the fibers 101-103 can be reduced or eliminated. The plausibility of this can be shown by the following example. For example, the three fibers 101-103 could be arranged in such a manner that the longitudinal axes 101-103 and the central axis 220 all lie in one plane. Then, the rotational symmetry would be two-fold (and not three-fold as in the example of FIG. 3). In such a case, the orthogonal transverse modes (different directions perpendicular to the central axis 220) have different frequencies due to different moments of inertia. As a result, for example, the direction of the low-frequency transverse mode rotates together with the rotation of the fibers 101-103 when the torsion mode is induced. Thereby, a parametric oscillator is formed, since the natural frequencies vary as a function of the rotation angle and thus as a function of time. The transfer of energy between the different states of the parametric oscillator results in nonlinearities. By the use of a rotational symmetry of high order, the formation of the parametric oscillator can be prevented. Preferably, the fibers can be arranged so that no dependency of the natural frequencies on the torsion angle occurs.

By avoiding nonlinearities when the torsion mode of the fibers 101-103 is induced, it is possible to achieve that particularly large scanning angles of the light 146 can be achieved by the torsion mode. For example, torsion angles of not less than 120° can be generated, and optionally of not less than 160°.

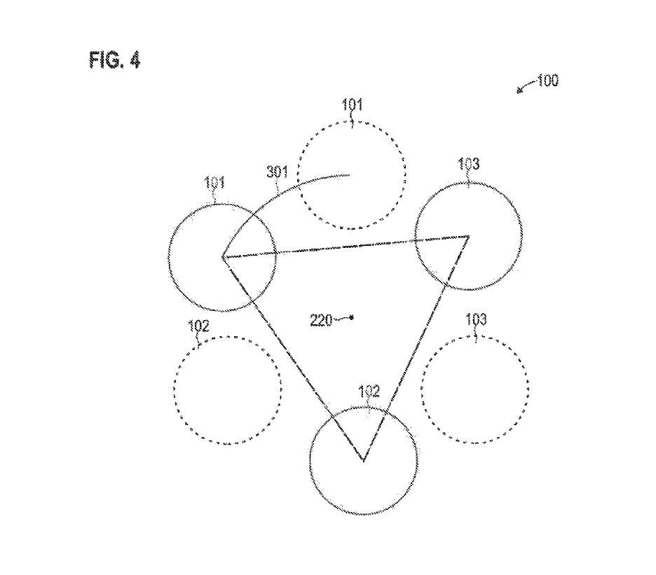

FIG. 4 illustrates aspects with regard to a fiber scanner 100 according to various examples. In particular, FIG. 4 illustrates aspects with regard to a degree of freedom of motion of the fibers 101-103 of the fiber scanner 100. In particular, FIG. 4 illustrates aspects with regard to a torsion mode 301.

The example of FIG. 4 corresponds in principle to the example of FIG. 3 (wherein, in FIG. 3, the resting state of the fibers 101-103 is represented; the resting state of the fibers 101-103 is represented with dotted lines in FIG. 4).

In FIG. 4, the torsion mode 301 is represented. The torsion mode 301 corresponds to a twisting of the fibers 101-103 about the central axis 220. As a result, the individual fibers 101-103 also are twisted along the longitudinal axes 111-113 thereof. The multiple fibers 101-103 are thus twisted both (I) into one another along the central axis 220 and also (II) in each case individually along the longitudinal axes 111-113 thereof. Therefore, the torsion mode 301 can also be referred to as coupled torsion mode 301 of the fibers 101-103. This is promoted in particular by the geometric arrangement of the fibers 101-103 with respect to one another, namely in particular by the parallel arrangement of the fibers 101-103 close to one another that is to say with a particularly small distance between the fibers 101-103 in comparison to the length thereof This coupled torsion mode 301 can be referred to as parallel kinematics of the fibers 101-103. By the torsion mode 301, for example, the mirror 145 of the deflecting unit 142 could be turned, so that the light 146 is emitted at different angles.

The twisting of the fibers into one another along the central axis 220 and the twisting of the fibers 101-103 along the longitudinal axes thereof increase with greater distances to the fastening means 141 and with greater torsion angles. For example, if the torsion angle of the torsion mode 301 is greater than the angular distance between the fibers 101-103 (120° in the example of FIG. 4 due to the three-fold rotational symmetry), a complete twisting with longitudinal overlap of the fibers 101-103 into one another is present. Thus, in general, the torsion angle of the torsion mode 301 can be greater than 360°/n, wherein n describes the order of the rotational symmetry. Thereby, the twisting of the fibers 101-103 into one another is promoted. This parallel kinematics allows large scanning angles with simultaneously low nonlinear effects and low space requirement.

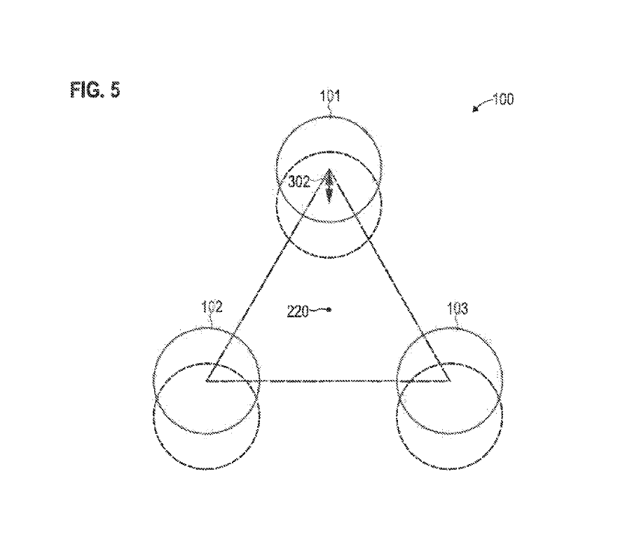

FIG. 5 illustrates aspects with regard to the fiber scanner 100 according to various examples. In particular, FIG. 5 illustrates aspects with regard to a degree of freedom of motion of the fibers 101-103 of the fiber scanner 100. In particular, FIG. 5 illustrates aspects with regard to a transverse mode 302.

The example of FIG. 5 corresponds in principle to the example of FIG. 3 (wherein the resting state of the fibers 101-103 is represented in FIG. 3; the resting state of the fibers 101-103 is represented with dotted lines in FIG. 5).

In FIG. 5, the transverse mode 302 is represented. The transverse mode 302 corresponds to deflection of the fibers 101-103 perpendicularly to the central axis 220. By means of the transverse mode 301, for example, the mirror 145 of the deflecting unit 142 could be shifted with respect to the central axis 220 and tilted in some examples, so that the light 146 is emitted in the case of a tilt at different angles.

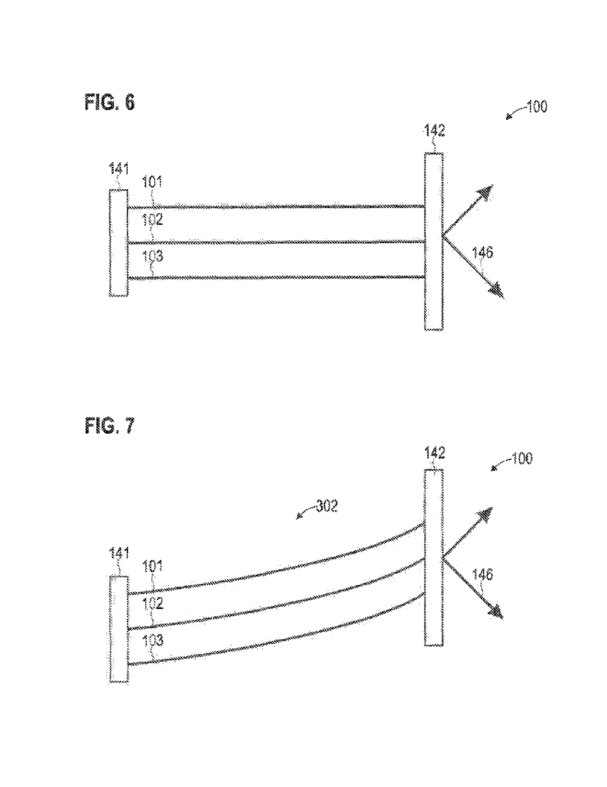

FIGS. 6 and 7 illustrate aspects with regard to a fiber scanner 100 according to various examples. In particular, FIGS. 6 and 7 illustrate aspects with regard to a degree of freedom of motion of the fibers 101-103 of the fiber scanner 100. In particular, FIGS. 6 and 7 illustrate aspects with regard to the transverse mode 302.

In FIG. 6, the resting state of the fiber scanner 100 is represented. In FIG. 7, the deflected state of the fiber scanner 100 is represented. From FIG. 7 it is apparent that even in the case of a deflection of the mobile end of the fibers 101-103, no tilting of the deflecting unit 142 occurs. This means that the deflection of the light 146 in the deflected state corresponds substantially to the deflection of the light 146 in the resting state of the fiber scanner 100. This is the case because the fibers 101-103 have the same length 211.

Thereby, it can be achieved that undesired inducing of the transverse mode 302 (for example, due to an uneven ground over which a vehicle in which the fiber scanner 100 is arranged is traveling) has no or no significant influence on the scanning of the light 146. For example, for this purpose, the extent of the deflecting unit 142, for example in particular of the mirror 145, perpendicularly to the central axis 220 can be dimensioned larger than a typical amplitude of the transverse mode 302. For example, the mirror 145 could have a radius of less than 2 mm, optionally of less than 4 mm, moreover optionally of less than 7 mm, Typically, the torsion mode 301 is excited substantially more inefficiently by outside influences than the transverse mode 302; therefore, the fiber scanner 100 is particularly stable with respect to outside influences.

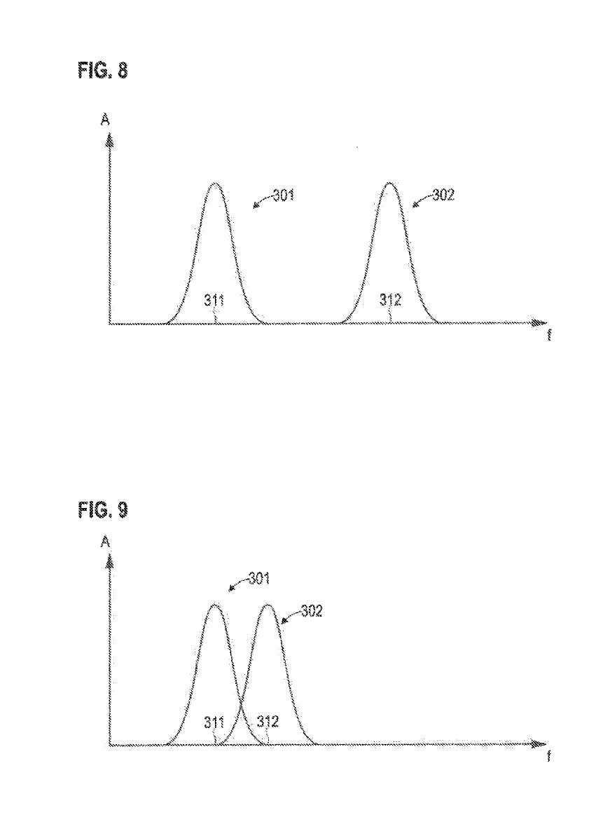

FIG. 8 illustrates aspects with regard to the degrees of freedom of motion 301, 302 of a fiber scanner 100 according to various examples. In particular, FIG. 8 illustrates a spectrum of the degrees of freedom of motion 301, 302.

In FIG. 8, the natural frequency 311 of the torsion mode is represented, as is the natural frequency 312 of the transverse mode 302. For example, it would be possible for the actuator to be configured to induce the torsion mode 301 at or close to the natural frequency 311 (resonant or semi-resonant scanning).

In the example of FIG. 8 it is apparent that the natural frequency 311 of the torsion mode 301 of lowest order is smaller than the natural frequency 312 of the transverse mode 302 of lowest order. In particular, the torsion mode 301 can thus constitute the fundamental mode of the kinematic system. This can be achieved, for example, in that the distance 210 between adjacent fibers 101-103 is dimensioned relatively large (compare FIG. 3). Thereby, the moment of inertia of the fibers 101-103 is in fact increased. By increasing the distance 210, in particular the natural frequency 311 of the transverse mode 301 is increased, wherein, however, the natural frequency 312 of the torsion mode 302 is not or not significantly changed. Thereby, by appropriate dimensioning of the distance 210, it can be achieved that the torsion mode 301 has a particularly low natural frequency 311, in particular in comparison to natural frequency 312 of the transverse mode 302. For example, the distance 210 could be in the range of 2% to 50% of the length 211, optionally in the range of 10% to 40%, moreover optionally in the range of 12% to 20%. In particular, by means of such techniques, the lowest frequency inducing of the fibers 101-104 can be the torsion mode 301.

The use of relatively low natural frequencies 311 for the torsion mode 301 can have the following effect: undesired external influences (for example, due to an uneven ground over which a vehicle in which the fiber scanner 100 is arranged is traveling) can induce the torsion mode 301 only relatively inefficiently. This is the case since, typically, undesired external influences correspond to an in-phase motion in the area of the fastening means 141 with respect to the different fibers 101-103; a twisting in the area of the fastening means 141 often does not occur or occurs only insignificantly. However, higher frequency components in the range of the natural frequency 312 of the transverse mode 302 occur relatively rarely. Therefore, a corresponding fiber scanner 100 is particularly robust with respect to outside interferences.

In the example of FIG. 8, degeneration between the torsion mode 301 and the transverse mode 302 is eliminated. This is the case since the resonance curves do not have an overlapping region in which both amplitudes have significant values (for example, of more than 5% or more than 10% with respect to the respective maximum). The elimination of degeneration between the torsion mode 301 and the transverse mode 302 can be achieved, for example, by appropriate dimensioning of the lengths 211 with respect to the distance 210. Other system parameters could also be changed, such as, for example, the diameter of the deflecting unit 142 or the provision of a balancing weight. By the elimination of degeneration, non-linear effects due to couplings between the different degrees of freedom of motion can be reduced or avoided.

In FIG. 9, an example is represented, in which degeneration between the torsion mode 301 and the transverse mode 302 is not eliminated. FIG. 9 otherwise corresponds substantially to FIG. 8. Such an example can be particularly desirable if a temporally or spatially superposed inducing of the transverse mode 302 100 torsion mode 301 is desired, for example, in order to enable a two-dimensional scanning of the light 146 with a superposition figure.

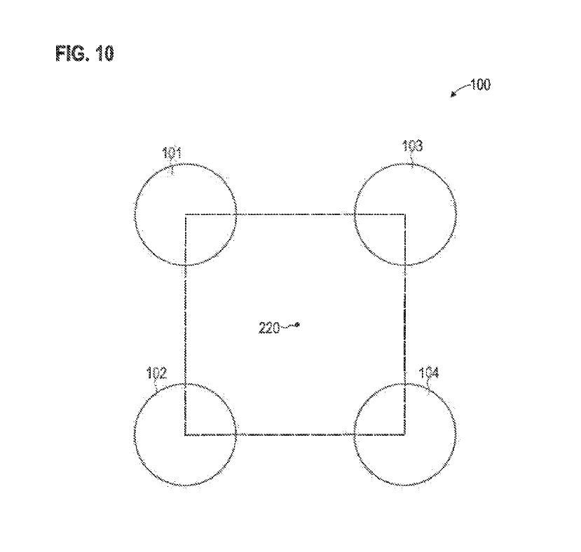

While various examples with regard to a fiber scanner with a number of three fibers 101-104 were described above, corresponding examples can also be implemented for a fiber scanner 100 having a larger number of fibers. For example, in FIG. 10, an example is represented, in which the fiber scanner 100 has a number of four fibers 101-104. Here, the fibers 101-104 are arranged rotationally symmetrically with respect to the central axis 220 with four-fold rotational symmetry. The fibers 101-104 are arranged at the corners of a square. In the scenario of FIG. 10 too the coupled torsion mode 301 can be induced, in which a twisting of the fibers 101-104 about the central axis 220 thereof and a twisting of each individual fiber 101-104 about the respective longitudinal axis thereof (not shown in FIG. 10, perpendicular to the plane of the drawing) occur. In general, the angular distance between the fibers 101-104 (90° in the example of FIG. 10 due to the four-fold symmetry) can thus be smaller than the torsion angle which can be >90°, for example, optionally >120°, moreover optionally >160°.

Naturally, the features of the above-described embodiments and aspects of the invention can be combined with one another. In particular, the features can be used not only in the described combinations, but also in other combinations or taken alone, without leaving the scope of the invention.

1. A device which comprises:
at least two fiber-shaped elements which are arranged between a fastening means and a deflecting unit,
the deflecting unit which is configured to deflect light, and
an actuator which is configured to induce at least one degree of freedom of motion of the at least two fiber-shaped elements in a coupled manner,
wherein the at least one degree of freedom of motion comprises a torsion mode.

2. The device according to claim 1,
wherein the longitudinal axes of the at least two fiber-shaped elements pairwise in each case enclose angles with one another which are not greater than 45°.

3. The device according to claim 2, wherein a beam path of the light extends, at least in a subregion, parallel to a central axis of the at least two fiber-shaped elements.

4. The device according to claim 1,
wherein, when the torsion mode is induced, a twisting of the at least two fiber-shaped elements into one another about a central axis of the at least two fiber-shaped elements occurs, and a twisting of each fiber-shaped element of the at least two fiber-shaped elements about the corresponding longitudinal axis occurs.

5. The device according to claim 1,
wherein the deflecting unit comprises an end piece on which a mirror is attached,
wherein the at least two fiber-shaped elements are arranged between the fastening means and the end piece.

6. The device according to claim 5,
wherein the mirror has a tilt with respect to the longitudinal axes of the at least two fiber-shaped elements.

7. The device according to claim 6,
wherein the tilt is in the range of 30°-50°.

8. The device according to claim 5,
wherein the end piece is arranged on a back side of the mirror.

9. The device according to claim 1,
wherein the device is configured to scan the light in the manner of a periscope by inducing the torsion mode.

10. The device according to claim 1,
wherein the at least two fiber-shaped elements extend away from a back side of a mirror of the deflecting unit and toward the fastening means.

11. The device according to claim 1,
wherein the at least two fiber-shaped elements comprise an arrangement with rotational symmetry with respect to a central axis.

12. The device according to claim 11,
wherein the rotational symmetry is n-fold, wherein n denotes the number of the at least two fiber-shaped elements.

13. The device according to claim 12,
wherein a torsion angle of the torsion mode is greater than 360°/n.

14. The device according to claim 12,
wherein the rotational symmetry is four-fold.

15. The device according to claim 1,
wherein the natural frequency of the lowest transverse mode of the at least two fiber-shaped elements is greater than the natural frequency of the lowest torsion mode.

16. The device according to claim 1,
wherein the distance between two adjacent fiber-shaped elements of the at least two fiber-shaped elements is in the range of 2%-50% of the length of at least one of the at least two fiber-shaped elements.

17. The device according to claim 1,
wherein the at least two fiber-shaped elements have lengths which differ from one another by not more than 10%.

18. The device according to claim 1,
wherein the actuator is configured to excite the at least two fiber-shaped elements in a coupled manner via the fastening means.

19. A method which comprises:
by means of an actuator: inducing of a torsion mode of at least two fiber-shaped elements which are arranged between a fastening means and a deflecting unit, wherein the deflecting unit is configured to deflect light,
whereby a twisting of the at least two fiber-shaped elements into one another about a central axis of the at least two fiber-shaped elements occurs, and a twisting of each fiber-shaped element of the at least two fiber-shaped elements about the corresponding longitudinal axis occurs.
